(19) United States
(12) Patent Application Publication
(10) Pub. No.: US 2017/0041589 A1
(43) Pub. Date: Feb. 9, 2017

(54) NON-LINEARITY CORRECTION IN PHASE-TO-DEPTH CONVERSION IN 3D TIME OF FLIGHT SYSTEMS

(71) Applicant: TEXAS INSTRUMENTS INCORPORATED, Dallas, TX (US)

(72) Inventors: Bharat PATIL, Bangalore (IN); Jagannathan VENKATARAMAN, Bangalore (IN); Karthik RAJAGOPAL, Bangalore (IN)

(21) Appl. No.: 15/231,261

(22) Filed: Aug. 8, 2016

(30) Foreign Application Priority Data
Aug. 6, 2015 (IN) 4114/CHE/2015

(51) Int. Cl. H04N 13/02

(52) U.S. Cl. CPC H04N 13/0246; H04N 13/0253

(57) ABSTRACT

A time-of-flight (TOF) camera system for correcting non-linearity in phase-to-depth measurements. The TOF camera system includes a module to simulate movement of a target object by generating delays between modulation signals emitted from a transmitter and demodulation signals received by a sensor. For each delay, the TOF system calculates and stores a phase output corresponding to a simulated distance of the target object. The TOF camera may consult the stored data during normal operation to perform in-field calibration.

### CROSS-REFERENCE TO RELATED APPLICATIONS

The present application claims priority to India Provisional Patent Application No. 4114/CHE/2015, filed Aug. 8, 2015, titled “Non-Linearity Correction In Phase-To Depth Conversion In 3D Time Of Flight (TOF) Systems,” which is hereby incorporated herein by reference in its entirety.

### BACKGROUND

Three-dimensional (3D) imaging systems may employ time-of-flight (TOF) cameras for various applications such as detecting gestures and locating objects. A TOF camera typically comprises an illumination source for emitting modulated light onto a target object and a pixel array detector for detecting light signals reflected from the target object. The TOF camera measures the time delay involved in the transmission of light from the illumination source and back to the pixel array. This round trip transmit time is measured as a phase difference, which the TOF camera may use along with the known speed of light to calculate distance. The distance calculated for each pixel may be used to generate a depth map representing a 3D image of the target object. Ideally, a camera system should generate a perfectly linear mapping between phase and distance measurements. Yet in practice, harmonics from components such as the illumination source and pixel array detector cause non-linearity errors.

A TOF camera may implement a calibration process to compensate for errors due to harmonics and/or other factors. For example, the TOF camera may obtain a set of measurements between each pixel and the target object as it is moved along various points of the scene. These measurements may be stored in a lookup table (LUT) and later used during operation to calibrate data obtained by the TOF camera. However, this calibration process may be difficult to implement in the field, as customers may not be expected to have a calibrated optical bench on which the distance between the camera and target object can be accurately changed. In addition, second order effects may adversely affect linearity measurements since the intensity of light can vary at different distances between the TOF camera and target object. Accordingly, it would be desirable to provide an improved calibration method to compensate for non-linearity errors in TOF camera systems.

### SUMMARY

In an aspect, a method is provided for calibrating measurements obtained by a time of flight (TOF) camera system. The method includes selectively emitting light from an illumination source toward a target object for a predetermined number of cycles, and shifting a phase input used to modulate light emitted from the illumination source such that light emitted from the illumination source is modulated with a different phase per cycle. The method further includes measuring phase differences between light emitted from the illumination source and light reflected from the target object as the phase input is shifted per cycle, and using the phase difference measurements to calibrate errors in TOF data obtained during operation of the TOF camera system.

In another aspect, a time of flight (TOF) camera system is provided comprising an illumination source configured to selectively emit light toward a target object for a predetermined number of cycles. The TOF camera system includes a delay module configured to shift a phase input used to modulate light emitted from the illumination source such that light emitted from the illumination source is modulated with a different phase per cycle. The TOF camera system further includes at least one sensor configured to detect light reflected from the target object per cycle, and a computation unit configured to calculate phase differences between light emitted from the illumination source and light reflected from the target object as the phase input is shifted per cycle. The computation unit may be coupled to a correction unit configured to use the phase difference measurements to calibrate errors in TOF data obtained during operation of the TOF camera system.

In yet another aspect, an apparatus is provided for calibrating a camera system. The apparatus comprises a frequency multiplier configured to multiply a modulation clock generated by the camera system, a frequency divider configured to divide the multiplied modulation clock into a plurality of clock signals, and a multiplexer configured to sequentially select the clock signals to generate phase delays between modulation light signals emitted from an illumination source and demodulation light signals reflected by a target object responsive to emitting the modulation light signals. The apparatus further includes a computation unit configured to calculate phase differences between the modulation light signals and the demodulation light signals, where the phase differences are used to calibrate the camera system.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a time of flight (TOF) camera system according to an embodiment of the present disclosure.

FIG. 2 is a schematic diagram of a phase stepping block depicted in FIG. 1.

FIG. 3 is a flowchart illustrating a method for generating phase shifts according to an embodiment of the disclosure.

FIG. 4 is a schematic diagram of a correction block depicted in FIG. 1.

FIG. 5 is a schematic block diagram illustrating an embodiment of a component system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are embodiments for correcting non-linearity in phase-to-depth measurements during operation of a time of flight (TOF) camera system. The TOF camera system includes a phase-shifting module to simulate movement of a target object by generating delays between modulation signals emitted from at least one transmitter and demodulation signals received by at least one receiver. For each generated delay, the TOF system calculates a phase output corresponding to a simulated distance of the target object. The TOF camera may use the calculated phase results to create a look-up table (LUT), which may be consulted during normal operation to perform in-field calibration. By simulating movement of an object electrically rather than physically or mechanically moving the object, the TOF camera system may perform calibration in a time-efficient manner.

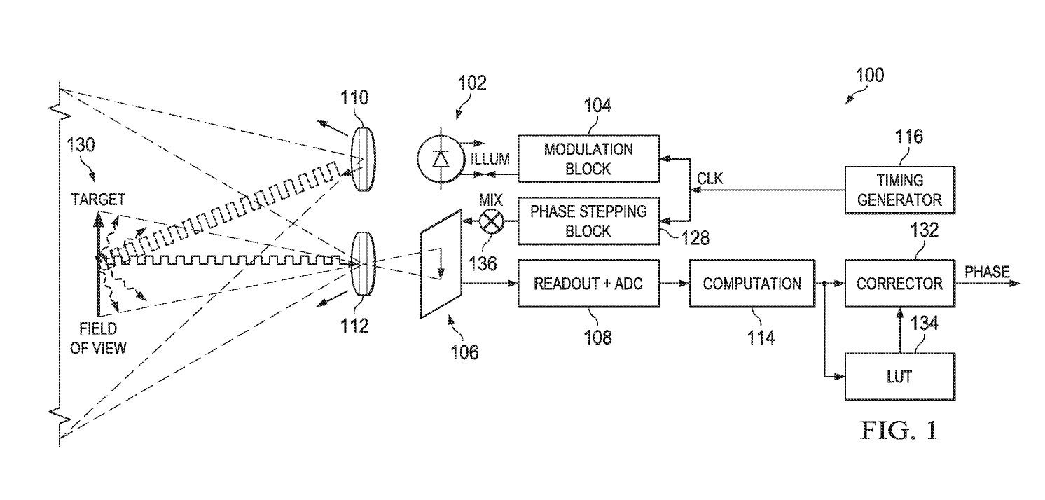

Referring to FIG. 1, a TOF camera system embodying the principles of the present disclosure is illustrated therein and designated as 100. The TOF camera system 100 comprises at least one light transmitter 102 coupled to a modulation block 104, and a receiving unit 106 coupled to an analog front-end (AFE) block 108. The light transmitter 102 may comprise various types of illumination sources such as a light emitting diode (LED), lasers, precision incandescent lights, shuttered light sources, etc. The receiving unit 106 may take the form of an array comprising pixels capable of demodulating incoming modulated light signals. However, it is to be understood that the receiving unit 106 may comprise any suitable imaging sensor(s). In some examples, the receiving unit 106 may be implemented as and alternatively referred to as a pixel array, but in other examples the receiving unit 106 and a pixel array may be implemented as distinct components. Moreover, the light transmitter 102 and receiving unit 106 may include or be coupled to various optical elements such as lenses, prisms, or the like. Briefly, for example, one or more optics 110 may be employed to collimate light emitted from the transmitter 102, and at least one lens 112 may be employed to focus incoming light onto the receiving unit 106.

The AFE block 108 may include an analog-to-digital converter (ADC) and circuitry to readout/process analog data (e.g., pixel values) from the receiving unit 106 and convert such analog data to digital signals, which may be processed by a computing unit such as computation block 114 coupled to the AFE block 108. The computation block 114 may be implemented on a chip such as an integrated circuit (IC), which may comprise various components such as, but not limited to, a microprocessor, microcontroller, input/output (I/O) circuitry, and memory configured to store instructions/code executable by the computation block 114. According to some implementations, the AFE 108 may include or be coupled to at least one amplifier used to amplify data obtained from the receiving unit 106.

The TOF camera system 100 further comprises a timing generator 116 coupled to the modulation block 104 and a delay module such as phase stepping block 128, which will be described in detail below. The timing generator 116 may comprise any suitable timing circuitry or mechanism such as an oscillator or clock configured to generate timing signals to control operation (e.g., exposure time, frame rate) of the TOF camera system 100 and components thereof. For example, the timing generator 116 may coordinate operation of the receiving unit 106 such that demodulation of modulated light at the pixel array is synchronous with the modulation of the light transmitter 102.

In general, the timing generator 116 may supply clock signals to the modulation block 104 to control modulation of the light transmitter 102 and pixel array 106. The clock signals may be generated by a modulation clock (not shown) coupled to or integrated with the timing generator 116. According to one aspect, the timing generator 116 may output a clock signal (CLK) to the modulation block 104, which may subsequently drive the light transmitter 102 to emit modulated light towards a target object 130. Modulated light reflected from the target object 130 to the receiving unit 106 may be demodulated by its pixel array. Each pixel within the pixel array may be configured to measure the flight time of modulated light from the light transmitter 102 to the target object 130 and back to the receiving unit 106.

The receiving unit 106 may output signals demodulated by the pixel array to the AFE 108, which may process and convert the demodulated signals to digitized output signals for further processing by the computation block 114. Based on a digitized output signal, the computation block 114 may calculate a difference in phase of a modulated light signal emitted by the light transmitter 102 and a demodulated signal output by the receiving unit 106. In some aspects, the computation block 114 may calculate phase differences between modulation signals emitted by the light transmitter 102 and demodulation signals received from the receiving unit 106 over a series of measurements.

For example, in a typical “4-quad” scenario, the timing generator 116 may generate timing signals that cause the modulation block 104 to delay the phase between modulation signals (e.g., via light transmitter 102) and demodulation signals (e.g., via receiving unit 106) by 0°, 90°, 180°, and 270° at four respective measurement periods such as quads Q1, Q2, Q3, Q4. The corresponding measurements may be used to obtain in-phase (I) and quadrature (Q) data, where I=Q1−Q3 and Q=Q2−Q4. The computation block 114 may then calculate phase (P) using the following equation: P=tan⁻¹ (Q/I). According to one aspect, results obtained from the computation block 114 may be output to a correction unit such as corrector block 132 for calibration purposes. Additionally or alternatively, results from the computation block 114 may be stored in a lookup table (LUT) 134 accessible by the corrector block 132.

In an embodiment, the phase stepping block 128 is operable to shift the phase between modulation signals and demodulation signals to simulate movement of a target object 130 at a fixed location in relation to the TOF camera system 100. That is, rather than actually moving the target object 130 (or the TOF camera system 100), the phase stepping block 128 may introduce a plurality of phase shifts to simulate moving the target object 130 along a plurality of different points. For each phase shift, light emitted from the light transmitter 102 is modulated at a different phase and light reflected onto to the receiving unit 106 is demodulated by the pixel array. The computation block 114 then calculates phase outputs resulting from each phase shift.

In some aspects, the receiving unit 106 may comprise a mixer 136 coupled to the phase stepping block 128 and/or the modulation block 104. In other aspects, the receiving unit 106 and mixer 136 may be implemented as distinct components coupled to one another. The mixer 136 may be configured to mix a reflected light signal detected by pixel array 106 with a signal used to modulate the light transmitter 102. The computation block 114 may calculate the phase difference between the mixed signals, e.g., using quantum efficiency modulation, homodyne detection, or the like. To enable in-field calibration, the TOF camera system 100 may generate a look-up table 134 using the phase outputs calculated by the computation block 114. This way, the corrector block 132 may consult data stored in the LUT 134 to correct errors in actual phase measurements obtained during normal operation of the TOF camera system 100.

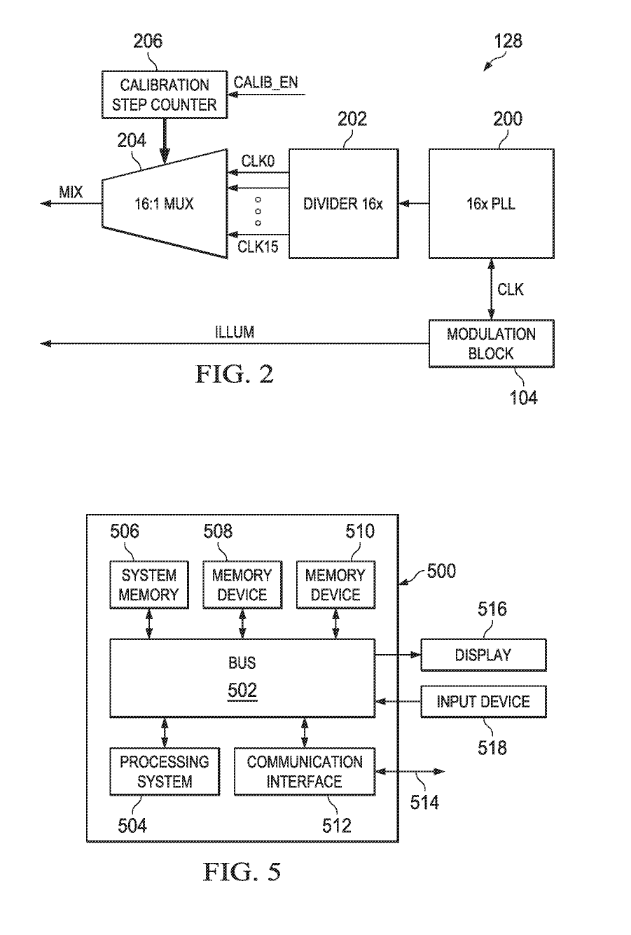

FIG. 2 depicts a block diagram of the phase stepping block 128 according to an implementation of the present disclosure. The phase stepping block 128 depicted in FIG. 2 is based on an implementation for generating 16 phase shifts, but the principles of the phase stepping block 128 are similarly applicable to any number (N) of phase shifts. In other implementations, the number (N) of phase steps may be more or less than 16, e.g., depending on resolution requirements, system specifications, etc. Thus, it is to be understood that components of the phase stepping block 128 may be reprogrammed and/or replaced to accommodate any desired number of phase shifts. It is also to be understood that the phase stepping block 128 is not limited to the implementation depicted in FIG. 2. In other aspects, the phase stepping block 128 may comprise any suitable component(s) capable of generating phase delays, shifting phases, or the like. Without limitations, such components may include one or more of the following: delay-locked loop (DLL), analog phase-locked loop (APLL), linear phase-locked loop (LPLL), digital phase-locked loop (DPLL), all digital phase-locked loop (ADPLL), software phase-locked loop (SPLL), variable frequency oscillator (VCO), phase detector, loop filter, etc.

As shown in FIG. 2, the phase stepping block 128 may comprise a phase-locked loop (PLL) 200, a clock frequency divider 202, a multiplexer 204, and a calibration step counter 206. The PLL 200 is configured to multiply a signal from a clock (not shown) by a certain frequency. For example, the timing generator 116 depicted in FIG. 1 may comprise a modulation clock configured to generate a clock signal (CLK) comprising a frequency equal to 1 megahertz (MHz). In this example, the PLL 200 would output a 16 MHz clock signal to the divider 202, which would divide the 16 MHz clock signal to generate 16 clock signals (CLK0, CLK1, . . . CLK15). The multiplexer 204 may then individually select these signals based on a status of the calibration step counter 206. In some implementations, the PLL 200 may be replaced by any suitable frequency multiplier comprising circuitry configured to multiply a frequency of a signal.

The calibration step counter 206 may include or be coupled to a processing device configured to generate a calibration enable signal (CALIB_EN) to enable the calibration step counter 206. Enabling the calibration step counter 206 causes the multiplexer 204 to select one of the 16 clock signals (CLK0, CLK1, . . . CLK15) in relation to the phase supplied from the modulation block 104 to the light transmitter 102. When the calibration step counter 206 is initially enabled (e.g., to begin a calibration process), the multiplexer 204 selects CLK0 from the divider 202 and outputs a signal (e.g., MIX0) to the mixer 136. The computation block 114 may then calculate a resulting phase output (e.g., Phase_Out0), e.g., the phase difference between the modulated light emitted from the light transmitter 102 and the reflected light demodulated by the receiving unit 106.

Next, the calibration step counter 206 increment its count by one, thus causing the multiplexer to select CLK1 and output a new signal (e.g., MIX1). Due to the phase shift, the new signal (e.g., MIX1) supplied to the mixer 136 may be slightly delayed (e.g., 1/16) from CLK0. The computation block 114 then calculates the resulting phase output (e.g., Phase_Out1). This process is repeated until the computation block 114 calculates a phase output for each of the clock signals selected by the multiplexer 204. The computation block 114 may perform these calculations during a frame of camera exposure, where each frame comprises multiple quads. The relationship between the phases used to modulate the light transmitter 102 and the resulting phase outputs (Phase_Out0, Phase_Out1, . . . Phase_Out15) for each clock signal (CLK0, CLK1, . . . CLK15) may be stored in the LUT 134. During normal operation of the TOF camera 100 (e.g., while calibration step counter 206 is disabled), the corrector 132 may utilize the data stored in the LUT 134 to correct phase-to-depth non-linearity errors.

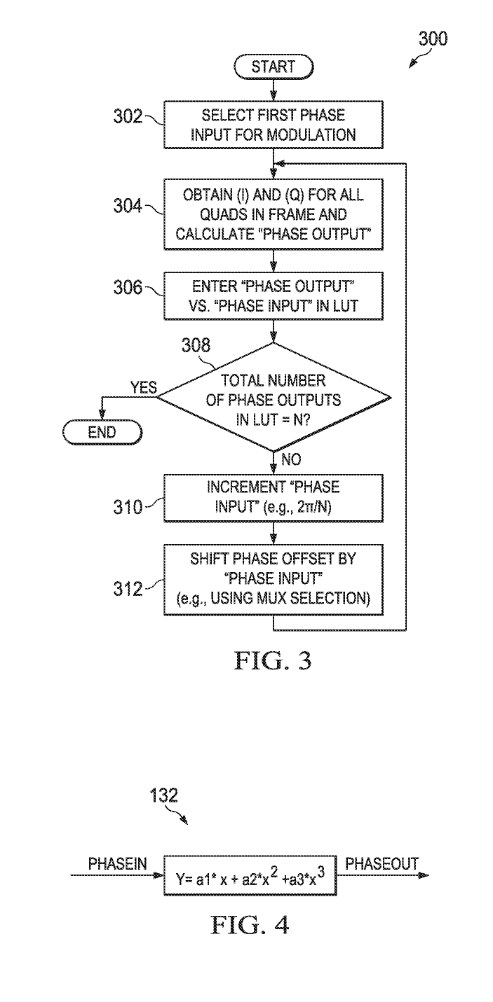

FIG. 3 depicts a method 300 of generating phase delays between modulation signals and demodulations signals in an imaging system such as the TOF camera system 100. The operations may be performed in the order shown, or in a different order. Further, two or more of the operations may be performed concurrently instead of sequentially. In an embodiment, the method 300 may employ a phase delay module such as the phase stepping block 128 to generate any number N of phase delays, where N is a positive integer greater than or equal to 1. The method 300 commences at block 302, where a first phase input is used to modulate light emitted from the light transmitter 102 during a frame comprising multiple intervals. As previously discussed, the phase input may be derived from a modulation clock. Moreover, the frame intervals may comprise four quads Q1, Q2, Q3, Q4 offset from one another by a fixed phase such as 90°. In some aspects, the intervals may comprise a different number of quads and/or a different phase offset may be used. In other aspects, a variable phase offset value may be used to delay the quads.

At block 304, a first phase output is calculated based on in-phase (I) and quadrature (Q) data obtained from the fours quads (Q1-Q4). At block 306, the relationship between the first phase input and first phase output is populated in an entry of a storage device such as the LUT 134. At block 308, the method 300 determines whether the number of phase outputs in the LUT is equal to N. If so, the method 300 ends. Otherwise, the method 300 proceeds to block 310, where the previous phase input is incremented by a predetermined value such as, but not limited to, 2π/N (alternately expressed as 360°/N). At block 312, the method 300 shifts the phase offset by the phase input to generate a second phase input. For example, after the first phase output (Phase_Out0) is calculated during for a first cycle (e.g., CLK0), the phase offset may be shifted when the multiplexer 204 selects a subsequent clock signal (e.g., CLK1). After block 312, the method 300 returns to block 304 where a second phase output is calculated based on in-phase (I) and quadrature (Q) data obtained from the fours quads (Q1-Q4).

At block 306, the method 300 populates the relationship between the second phase input and second phase output in an entry of the LUT 134. At block 308, the method 300 determines whether the number of phase outputs in the LUT 134 is equal to N. If so, the method 300 ends. Otherwise, the method 300 repeats beginning at block 310 until the method 300 determines that the number of phase outputs in the LUT 134 is equal to N.

As previously mentioned, the data populated in the LUT 134 (e.g., via method 300) may be used by the corrector block 132 to implement a calibration process. In an embodiment, the corrector block 132 may implement such a calibration process to dynamically compensate for non-linearity errors during operation of the TOF camera system 100. For example, FIG. 4 depicts a block diagram of the corrector block 132 using a polynomial equation for error correction. In this example, x denotes “phase input” and Y denotes “phase output,” while a1, a2, and a3 denote coefficients. The corrector block 132 may be implemented on a chip such as an IC, which may comprise various components such as, but not limited to, a microprocessor, microcontroller, I/O circuitry, and memory configured to store instructions/code executable by the corrector block 132. The corrector block 132 may be configured to calculate coefficients a1, a2, and a3 using the data stored in the LUT 134. In some aspects, the corrector block 132 may determine optimal values for coefficients a1, a2, and a3 through experimentation and/or using additional data stored on one or more storage devices accessible by the corrector block 132.

As discussed further below with respect to FIG. 5, the various illustrative logical blocks, modules, circuits, and methods described herein may be implemented or performed with a general purpose processor, a Digital Signal Processor (DSP), Very-Large-Scale Integrated (VLSI) circuits or gate arrays, an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In some aspects, the various blocks, modules, circuits, methods, and systems disclosed herein may be implemented on any general-purpose network component, such as a computer or network component with sufficient processing power, memory resources, and network throughput capability to handle the necessary workload placed upon it. For example, FIG. 5 illustrates a block diagram of exemplary computing system 500 capable of implementing aspects of the systems and methods disclosed herein and depicted in FIGS. 1-4. The system 500 may include various systems and subsystems. The system 500 may comprise a personal computer, a laptop computer, a workstation, a computer system, an appliance, a “smart” phone, an ASIC, a server, a server blade center, a server farm, etc.

As shown in FIG. 5, the system 500 may comprise a system bus 502, a processing unit 504, a system memory 506, memory devices 508 and 510, a communication interface 512 (e.g., a network interface), a communication link 514, a display 516 (e.g., a video screen), and an input device 518 (e.g., a keyboard and/or a mouse). The system bus 502 can be in communication with the processing unit 504 and the system memory 506. The additional memory devices 508 and 510, such as a hard disk drive, server, stand-alone database, or other non-volatile memory, can also be in communication with the system bus 502. The system bus 502 interconnects the processing unit 504, the memory devices 506-510, the communication interface 512, the display 516, and the input device 518. In some examples, the system bus 502 also interconnects an additional port (not shown), such as a universal serial bus (USB) port.

The processing unit 504 may comprise a computing device and include an ASIC. The processing unit may further include a processing core. The processing unit 504 is capable of executing a set of instructions to implement the various operations of disclosed herein.

The additional memory devices 506, 508 and 510 can store data, programs, instructions, database queries in text or compiled form, and any other information that can be needed to operate a computer. The memories 506, 508 and 510 can be implemented as computer-readable media (integrated or removable) such as a memory card, disk drive, compact disk (CD), or server accessible over a network. In certain examples, the memories 506, 508 and 510 can comprise text, images, video, and/or audio, portions of which can be available in formats comprehensible to human beings. Additionally or alternatively, the system 500 can access an external data source or query source through the communication interface 512, which can communicate with the system bus 502 and the communication link 514.

In operation, the system 500 may be used to implement one or more aspects of a time of flight measurement system such as the TOF camera system 100 disclosed herein. Computer executable logic for implementing the system control may reside on one or more of the system memory 506, and the memory devices 508, 510. The processing unit 504 may be configured to execute one or more computer executable instructions originating from the system memory 506 and the memory devices 508 and 510. The term “computer readable medium” as used herein may refer to any suitable medium that participates in providing instructions to the processing unit 504 for execution, and can include either a single medium or multiple non-transitory media operatively connected to the processing unit 504.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for calibrating measurements obtained by a time of flight (TOF) camera system, the method comprising:
emitting light from an illumination source toward a target object for a predetermined number of cycles;
shifting a phase input used to modulate light emitted from the illumination source such that light emitted from the illumination source is modulated with a different phase per cycle;
measuring phase differences between light emitted from the illumination source and light reflected from the target object as the phase input is shifted per cycle; and
using the phase difference measurements to calibrate errors in TOF data obtained during operation of the TOF camera system.

2. The method of claim 1, wherein each cycle comprises a predetermined number of measurements periods, each period being offset from one another by a fixed phase.

3. The method of claim 2, further comprising:
obtaining in-phase (I) data and quadrature (Q) data for each cycle based on data acquired from the predetermined number of measurement periods; and
calculating a phase output based on the in-phase (I) data and quadrature (Q) data calculated per cycle.

4. The method of claim 3, further comprising:
storing the phase output and a particular phase input used to modulate emitted light during a particular cycle in which the phase output is calculated; and
generating a lookup table based on the stored phase outputs and inputs from the predetermined number of cycles.

5. The method of claim 1, further comprising:
generating a calibration function using the phase difference measurements as inputs; and
applying the calibration function to correct errors in phase outputs produced by the TOF camera system during normal operation.

6. The method of claim 5, wherein the calibration function comprises a polynomial equation.

7. The method of claim 1, further comprising:
multiplying a modulation clock by a predetermined frequency to generate a modulation clock signal;
dividing the modulation clock signal to generate a plurality of clock signals; and
sequentially selecting one of the clock signals to shift the phase input per cycle.

8. A time of flight (TOF) camera system comprising:
an illumination source configured to selectively emit light toward a target object for a predetermined number of cycles;
a delay module configured to shift a phase input used to modulate light emitted from the illumination source such that light emitted from the illumination source is modulated with a different phase per cycle;
at least one sensor configured to detect light reflected from the target object per cycle;
a computation unit configured to calculate phase differences between light emitted from the illumination source and light reflected from the target object as the phase input is shifted per cycle; and
a correction unit configured to use the phase difference measurements to calibrate errors in TOF data obtained during operation of the TOF camera system.

9. The TOF camera system of claim 8, wherein each cycle comprises a predetermined number of measurements periods, each period being offset from one another by a fixed phase.

10. The TOF camera system of claim 9, wherein the computation unit is further configured to:
obtain in-phase (I) data and quadrature (Q) data for each cycle based on data acquired from the predetermined number of measurement periods;
calculate a phase output based on the in-phase (I) data and quadrature (Q) data calculated per cycle; and
store the phase output and a particular phase input used to modulate emitted light during a particular cycle in which the phase output is calculated.

11. The TOF camera system of claim 8, wherein the delay module comprises:
a phase-locked loop (PLL) configured to multiply a modulation clock by a predetermined frequency;
a divider configured to divide the multiplied modulation clock into a plurality of clock signals; and
a multiplexer configured to shift the phase input by sequentially selecting one of the clock signals per cycle.

12. The TOF camera system of claim 8, wherein the correction unit is configured to apply a calibration function to correct errors in phase outputs obtained by the TOF camera system during normal operation, wherein the calibration function uses the phase difference measurements obtained from the predetermined number of cycles as inputs to correct the phase outputs.

13. The TOF camera system of claim 12, wherein the calibration function comprises a polynomial equation.

14. An apparatus for calibrating a camera system, the apparatus comprising:
a frequency multiplier configured to multiply a modulation clock generated by the camera system;
a frequency divider configured to divide the multiplied modulation clock into a plurality of clock signals;
a multiplexer configured to sequentially select the clock signals to generate phase delays between modulation light signals emitted from an illumination source and demodulation light signals reflected by a target object responsive to emitting the modulation light signals; and
a computation unit configured to calculate phase differences between the modulation light signals and the demodulation light signals, wherein the phase differences are used to calibrate the camera system.

15. The apparatus of claim 14, wherein the frequency multiplier comprises a phase-locked loop (PLL) configured to multiply the modulation clock by a predetermined frequency.

16. The apparatus of claim 14, wherein modulation light signals are selectively emitted by the illumination source for a predetermined number of cycles, each cycle comprising a predetermined number of quads offset from one another by a fixed phase, and wherein the computation unit calculates a phase difference during each cycle.

17. The apparatus of claim 14, further comprising a correction unit configured to use the phase difference calculations to calibrate the camera system.

18. The apparatus of claim 17, wherein the correction unit is configured to apply a calibration function to correct errors in phase outputs obtained by the camera system during normal operation, wherein the calibration function uses the phase differences calculated by the computation unit as inputs.

19. The apparatus of claim 18, wherein the calibration function comprises a polynomial equation.

20. The apparatus of claim 14, wherein the camera system comprises a time of flight (TOF) camera system.
